(19) United States
(12) Patent Application Publication
(10) Pub. No.: US 2009/0085801 A1
(43) Pub. Date: Apr. 2, 2009

(54) Method and Apparatus for Faster Global Positioning System (GPS) Location Using Pre-Downloaded Assistance Data

(76) Inventors: Uttam Sengupta, Portland, OR (US); Sanjay Bakshi, Beaverton, OR (US); Shriharsha Hegde, Beaverton, OR (US)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 11/864,817

(22) Filed: Sep. 28, 2007

(51) Int. Cl. G01S 1/00; H04B 7/185

(52) U.S. Cl. 342/357.1; 342/357.06; 342/357.15

(57) ABSTRACT

A method and apparatus for faster global positioning system (GPS) location using pre-downloaded assistance data are described. In one embodiment, the method includes the periodic acquisition of assistance data when a GPS receiver is disabled. In one embodiment, the GPS receiver may be disabled due to a spatial location of a mobile platform device (MPD) that includes the GPS receiver. During the periodic acquisition of the assistance data, the GPS receiver may be monitored. In one embodiment, in response to activation of the GPS receiver, the assistance data is provided to the GPS receiver to reduce a time to first fix (TTFF) following lock onto a predetermined number of visible satellites to establish a current spatial location of the MPD. Other embodiments are described and claimed.

### FIELD

Some embodiments relate to a method and apparatus for faster global positioning system (GPS) location using pre-downloaded assistance data.

### BACKGROUND

Mobile computing systems, such as laptop computers, notebook computers and handheld devices (e.g., personal digital assistants, cell phones, etc.) are often battery-powered; and, as such, power consumption is a matter of concern. Hence, mobile computing systems are limited to a run-time dictated by the life of a battery used by the respective device. A typical laptop's battery lasts about 5-8 hours. However, depending on the complexity of the mobile platform, the respective mobile platform can deplete power resources from an attached battery within a relatively short amount of time.

Today, many mobile devices are capable of entering a low power (“Sleep/Stand-by/Hibernate”) state to conserve battery power when not in active use. To conserve battery power, an individual either places his/her mobile device in the Stand-by/Hibernate state, or the device itself, if left idle, enters the state. Use of GPS and location based services is becoming a key usage model on mobile devices such as notebooks, UMPCs (Ultra Mobile PCs) and Mobile Internet Devices (MIDs). Unfortunately, a GPS receiver of a UMPC/MID system may be subject to a cold restart due to deactivation for power saving when GPS signals are weak.

### BRIEF DESCRIPTION OF THE DRAWINGS

The various embodiments of the present invention are illustrated by way of example, and not by way of limitation, in the figures of the accompanying drawings and in which:

FIG. 1 is a block diagram illustrating a mobile personal computer (MPC) system including global positioning system (GPS) management logic to enable faster GPS location using pre-downloaded assistance data of the MPC system, in accordance with one embodiment.

FIG. 2 is a block diagram further illustrating GPS management logic of FIG. 1, according to one embodiment.

FIG. 3 is a block diagram further illustrating warm reboot logic of the GPS management logic of FIG. 1, according to one embodiment.

FIG. 4 is a flowchart illustrating a method for acquiring GPS assistance data in an MPC system, according to one embodiment.

FIG. 5 is a flowchart illustrating a method for faster GPS location using pre-downloaded assistance data, according to one embodiment.

FIG. 6 is a block diagram illustrating a mobile platform architecture to provide a power efficient framework for faster GPS location using pre-downloaded assistance data, according to one embodiment.

### DETAILED DESCRIPTION

In general, a method and apparatus for faster global positioning system (GPS) location using pre-downloaded assistance data are described. In one embodiment, the method includes periodic acquisition of assistance data when a GPS receiver is disabled. In one embodiment, the GPS receiver may be disabled due to a spatial location of a mobile platform device (MPD) that includes the GPS receiver. During the periodic acquisition of the assistance data, the GPS receiver may be monitored. In one embodiment, in response to activation of the GPS receiver, the assistance data is provided to the GPS receiver to reduce a time to first fix (TTFF) following lock onto a predetermined number of visible satellites to establish a current spatial location of the MPD. In one embodiment, a warm reboot of the GPS receiver is described where the assistance data is provided to the GPS receiver to establish a current spatial location of the MPD if the GPS receiver is in a disabled state for more than a predetermined period of time, such as, for example, 30 minutes.

In the following description, numerous specific details such as logic implementations, sizes and names of signals and buses, types and interrelationships of system components, and logic partitioning/integration choices are set forth in order to provide a more thorough understanding. It will be appreciated, however, by one skilled in the art that the invention may be practiced without such specific details. In other instances, control structures and gate level circuits have not been shown in detail to avoid obscuring the invention. Those of ordinary skill in the art, with the included descriptions, will be able to implement appropriate logic circuits without undue experimentation.

In the following description, certain terminology is used to describe features of the invention. For example, the term “logic” is representative of hardware and/or software configured to perform one or more functions. For instance, examples of “hardware” include, but are not limited or restricted to, an integrated circuit, a finite state machine or even combinatorial logic. The integrated circuit may take the form of a processor such as a microprocessor, application specific integrated circuit, a digital signal processor, a micro-controller, or the like.

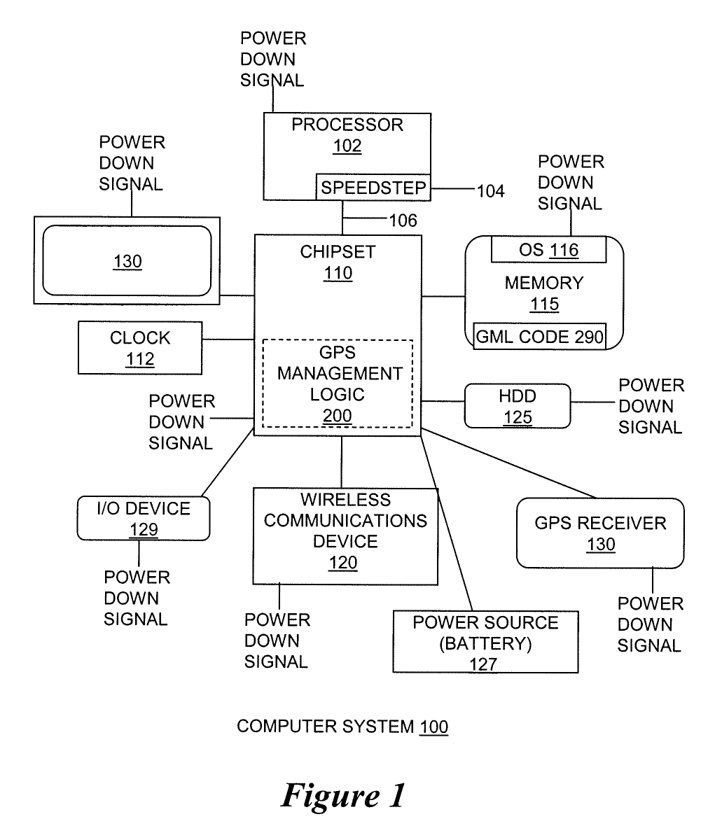

FIG. 1 is a block diagram illustrating mobile personal computer (PC) (MPC) or mobile platform device (MPD) system 100 including GPS management logic 200 to enable faster GPS location using pre-downloaded assistance data of MPC system 100, in accordance with one embodiment. As described herein, an “MPC system” may include, but is not limited to, laptop computers, notebook computers, handheld devices (e.g., personal digital assistants, ultra-mobile devices, cell phones, etc.), or other like battery powered devices.

Representatively, MPC system 100, which may be mreferred to herein as a “mobile platform architecture,” comprises a processor system bus (front side bus (FSB)) 104 for communicating information between processor (CPU) 102 and chipset 110. In one embodiment, CPU 102 may be a multi-core processor to provide a symmetric multiprocessor system (SMP) a chip multiprocessor system (CMP) or other like multi-core processor configuration. As described herein, the term “chipset” is used in a manner to collectively describe the various devices coupled to CPU 102 to perform desired system functionality.

Representatively, display 130, wireless communication device 120, hard drive devices (HDD) 125, main memory 115, clock 112, input/output (I/O) device 129 and direct current (DC) power source (battery) 127 may be coupled to chipset 110 to supply DC voltage to MPC system 100. Although shown as HDD 125, one of ordinary skill in the art would appreciate, based at least on the teachings described herein, that Solid State Drives (SSD) and other storage devises may also be used. In one embodiment, chipset 110 is configured to include a memory controller hub (MCH) and/or an I/O controller hub (ICH) to communicate with I/O devices, such as wireless communications device 120. In an alternate embodiment, chipset 110 is or may be configured to incorporate a graphics controller and operate as a graphics memory controller hub (GMCH). In one embodiment, chipset 110 may be incorporated into CPU 102 to provide a system on chip.

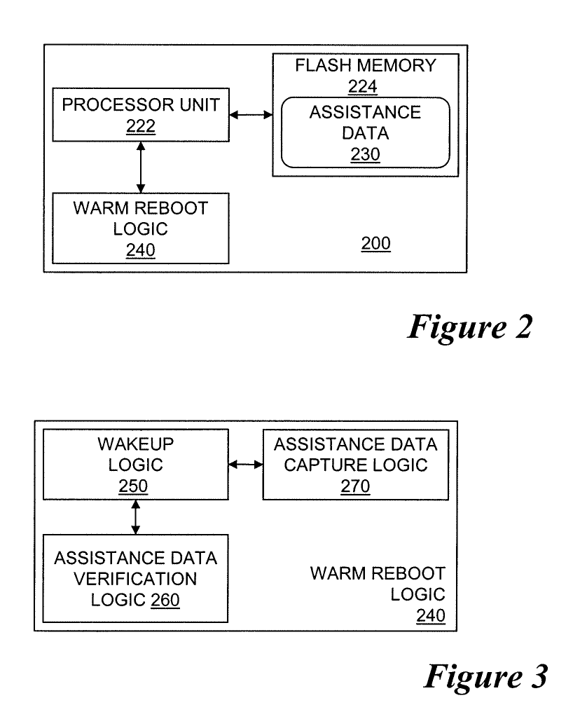

In one embodiment, main memory 115 may include, but is not limited to, random access memory (RAM), dynamic RAM (DRAM), static RAM (SRAM), synchronous DRAM (SDRAM), double data rate (DDR) SDRAM (DDR-SDRAM), Rambus DRAM (RDRAM) or any device capable of supporting high-speed buffering of data. Representatively, computer system 100 further includes non-volatile (e.g., Flash) memory 224 (shown in FIG. 2). In one embodiment, flash memory may be referred to as a “firmware hub” or FWH, which may include a basic input/output system (BIOS) that is modified to perform, in addition to initialization of computer system 100, initialization of GPS management logic 200 to enable faster GPS location using pre-downloaded assistance data for MPC system 100, according to one embodiment.

MPC/MPD systems, such as MPC system 100, laptop computers, notebook computers, Ultra Mobile PCs, Mobile Internet Devices, Smart Phones, handheld devices (e.g., personal digital assistants, cell phones, etc.) are often battery powered; and, as such, power consumption is a matter of concern. Examples of mobile computing devices, such as MPC system 100, may be a laptop computer, a cell phone, a personal digital assistant, or other similar device with on board processing power and wireless communications ability that is powered by a Direct Current (DC) power source that supplies DC voltage to the mobile device and that is solely within the mobile computing device and needs to be recharged on a periodic basis, such as a fuel cell or a battery.

Unfortunately, during either standby mode or hibernation mode, the utility of a mobile computing system is effectively non-existent because the CPU (being shut down) lacks the ability to execute a variety of instructions. That is, useful software routines (such as, e-mail retrieval, downloading information from the Internet, etc.) cannot be executed. In one embodiment, GPS management logic (GML) 200 periodically captures GPS assistance data using a wireless network connection to a GPS assistance server. In one embodiment, GPS management logic 200 provides an automated mechanism for faster GPS location using pre-downloaded assistance data.

GPS is a satellite based positioning technology. Satellites in the sky continually send information at a low-bit rate. GPS receivers need to receive signals from at least 3 satellites to calculate a horizontal position. A fourth satellite is necessary for altitude calculation and time correction. GPS receivers search for satellites in the sky. After finding the satellites, conventionally, boot strap data, i.e., precise orbital data and clock corrections for each of those satellites is downloaded. In conventional systems, it is only after acquisition of boot strap data that the receiver knows where the satellites are and uses triangulation algorithms to calculate its position. This boot strap data is downloaded at a low-bit rate directly impacting the TTFF.

Hence, GPS receivers, such as GPS receiver 130 as shown in FIG. 1, need to search for GPS satellites in the sky and get boot strap data from those satellites before calculating position (spatial location). In one embodiment, GPS management logic enables GPS receiver 130 to achieve a faster time to first fix (TTFF) by obtaining the required boot strap data prior to GPS search for visible satellites. As described here in the term TTFF may include but is not limited to an amount of time from turning on (or activating) a GPS receiver until at least three satellites are acquired and the position is fixed. As known to those skilled in the art, a GPS receiver calculates its position by measuring the distance between itself and 3 or more GPS satellites.

Measuring the time delay between transmission and reception of each GPS microwave signal gives the distance to each satellite, since the signal travels at a known speed. These signals also carry information about the satellite's location and general health, referred to herein as “boot strap data” which is known as almanac and ephemeris data. By determining the position of and distance to at least 3 satellites, a GPS receiver can compute its position using, for example, trilateration. Accordingly, in one embodiment, GPS management logic 200 provides a faster TTFF while at the same time consuming lower power, which leads to longer battery life. The longer battery life leads to an improved end-user experience by removing the delay associated with restart of a GPS receiver to provide location capability. Although shown as part of chipset 110, GPS management logic (GML) 200 may be wholly or partially implemented in any of chipset 110, operating system (OS) 116 or as GML code 290 of memory 115.

FIG. 2 is a block diagram, further illustrating GPS management logic 200, as shown in FIG. 1. Representatively, GPS management logic may include a processor unit 222, which computes a current spatial location of a MPC 100, using assistance data, such as ephemeris data and almanac data to establish or fix a position of the MPC 100. In one embodiment, GPS code 290, as shown in memory 115 of MPC system 100 of FIG. 1, may periodically acquire assistance data from a network connection via wireless communications device 120. GPS code 290 may store assistance data, such as assistance data 230, as shown in FIG. 2, and provide notification to GPS receiver 130 to turn on the GPS receiver, for example, in response to detection of a navigation message from a GPS satellite. In one embodiment, GPS management logic 200 in combination with warm reboot logic 240 and/or GPS code 290, are not limited to capturing of assistance data when a GPS module is turned on.

Hence, GPS receiver 130 needs almanac and ephemeris data from satellites to fix a spatial location of the MPC system. Almanac data is the course orbital parameters for all GPS satellites that are part of the constellation. Each satellite broadcasts the almanac data for all satellites, which usually remains valid for several days. Ephemeris data referred to herein as “boot strap data” is very precise orbital data and clock correction for each of the satellites necessary for position calculation. Each satellite generally broadcasts its ephemeris data every 30 seconds. However, ephemeris data is only valid for about 30 minutes. Accordingly, in one embodiment, warm reboot logic 240 is provided to periodically acquire assistance data 230, including almanac and ephemeris data.

FIG. 3 further illustrates warm reboot logic 240 as shown in FIG. 2, according to one embodiment. Representatively, wake up logic 250 may determine when the GPS is turned on. In such situations, the existing ephemeris data may be more than 30 minutes old. As a result, the GPS receiver is required to acquire new ephemeris data for each visible satellite from which a position calculation is determined. Unfortunately, the accessing or acquisition of ephemeris data from each satellite can exacerbate and is the main delay (at least 30 seconds) before getting a first fix.

In one embodiment, MPC 100 may be connected to the Internet via a wired or wireless technology, using for example, wireless communications device 120, as shown in FIG. 1. If the MPC 100 is connected to the Internet via wireless communications device 120, a client can download ephemeris and almanac data quickly via a high speed connection from the server on the Internet. Conventional GPS solution vendors or location service providers host assistance servers which provide the most current almanac and ephemeris data for all satellites that are part of the GPS constellation.

In one embodiment, acquisition of the assistance data is provided by assistance capture logic 270 and stored in flash memory 224, as shown in FIGS. 2 and 3. In one embodiment, pre-acquisition of assistance data greatly reduces the amount of time required to complete a time to first fix or TTFF by an order of magnitude. For example, the autonomous TTFF for a particular GPS vendor is about 50 seconds, however, with download assistance using, for example, warm reboot logic, as shown in FIG. 2, the TTFF may be reduced to less than 10 seconds, which may be crucial for perceived end-user experience.

Referring again to FIGS. 2 and 3, when GPS signals are weak, such as when MPC 100 is inside an enterprise office building, it is usually connected to the Internet via WiFi or wired connection. In one embodiment, assistance data capture logic 270 periodically downloads ephemeris and almanac data from a server when it is connected to the Internet and while inside a building. The periodic acquisition may be repeated every 15 to 20 minutes. When the owner of the mobile device steps out of the building, increased GPS signal strength may activate GPS receiver 130. In one embodiment, the periodic acquisition of the pre-downloaded ephemeris data ensures that such data is less than 20 minutes old and can be used right away by the activated GPS receiver 130 after locking onto visible satellites which may be detected in response to a navigation message.

Satellites continuously broadcasts navigation messages, at for example, 50 bits per second, which may give the time of day, GPS week number, satellite health information, and ephemeris (transmitted as the second part of the message) and almanac (later part of the message). The ephemeris data gives the satellites own precise orbit and output over 18 seconds, repeating every 30 seconds. However, the time needed to acquire the ephemeris data is a significant element of the delay to the first position fix because, as hardware becomes more capable, the time to lock onto the satellite signals shrinks while the ephemeris data requires 30 seconds (worst case) before it is received due to the low data transmission rate.

In one embodiment, wake up logic 250 may activate GPS receiver 130, as shown in FIG. 1 in response to detection of a navigation message outside a building. Once outside the building, although the wireless network connection for the client to the Internet is lost, TTFF will be improved over traditional assisted GPS because an amount of time required to capture ephemeris data from visible satellites is avoided. The pre-downloading of assistance can be made more efficient, in one embodiment, by configuring GPS management logic 200 to download the data less frequently during the day and more frequently at the end of the day during regular work at the office days. Procedural methods for implementing one or more of the embodiments are now described.

### Operation

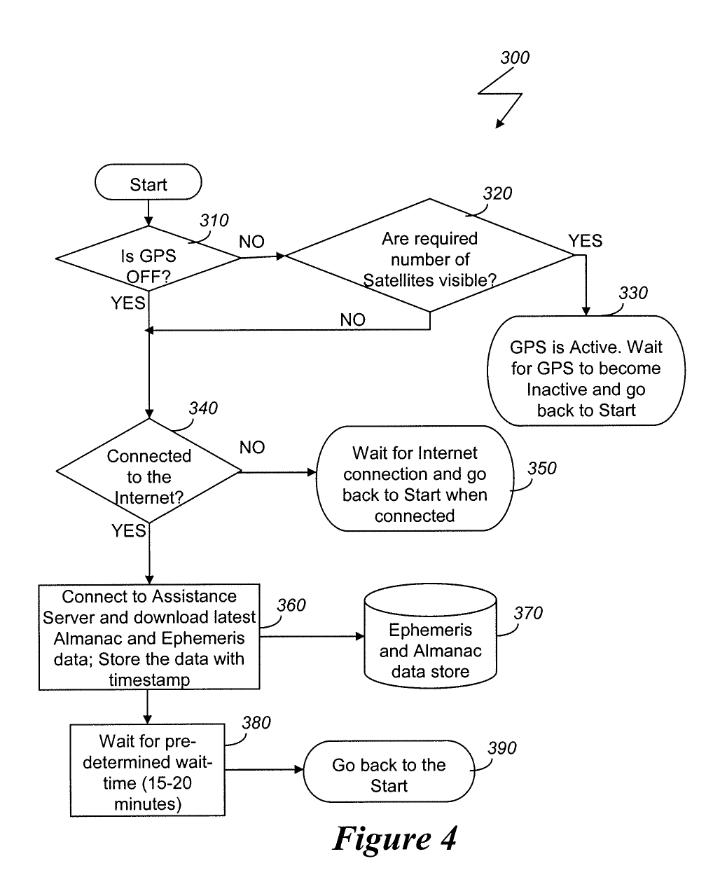

Turning now to FIG. 4, the particular methods associated with various embodiments are described in terms of computer software and hardware with reference to a flowchart. The methods to be performed by a computing device (e.g., an GPS receiver) may constitute state machines or computer programs made up of computer-executable instructions. The computer-executable instructions may be written in a computer program and programming language or embodied in firmware logic. If written in a programming language conforming to a recognized standard, such instructions can be executed in a variety of hardware platforms and for interface to a variety of operating systems.

In addition, embodiments are not described with reference to any particular programming language. It will be appreciated that a variety of programming languages may be used to implement embodiments as described herein. Furthermore, it is common in the art to speak of software, in one form or another (e.g., program, procedure, process, application, etc.), as taking an action or causing a result. Such expressions are merely a shorthand way of saying that execution of the software by a computing device causes the device to perform an action or produce a result.

FIG. 4 is a flowchart illustrating a method 300 for faster GPS location using pre-downloaded assistance data for mobile platforms, in accordance with one embodiment. As shown in FIG. 4, deactivation of the GPS receiver due to, for example, entry into a building which includes a wireless network, affords the ability to refresh time-sensitive assistance data, such as ephemeris data to enable a warm reboot or restart of a GPS receiver with a reduced time to first fix (TTFF) by avoiding a download time necessary to acquire refreshed ephemeris data from each visible satellite. In the embodiments described, examples of the described embodiments will be made with reference to FIGS. 1-3. However, the described embodiments should not be limited to the examples provided to limit the scope provided by the appended claims.

Referring again to FIG. 4, at process block 310, it is determined whether a GPS receiver is turned off. For example, the GPS receiver may be disabled or turned off in an effort to conserve power because the current spatial location of a mobile platform device or mobile personal computer, such as MPC system 100 of FIG. 1, is within a location that does not allow the receipt of a navigation message from a GPS satellite. If the GPS receiver is disabled, at process block 340 it is determined whether an Internet connection is available. Otherwise, when a GPS receiver is enabled, at process block 320 it is determined whether a required number of satellites are visible. When such required number of satellites are visible, control flow transitions to process block 330. At process block 330, the GPS is active, however, once the GPS becomes inactive due to deactivation of the GPS or movement of the user of the device control flow returns to the start block.

Referring again to FIG. 4, at process block 340, when an Internet connection is available, logic (e.g., wireless connection device 120 of FIG. 1) may connect to an assistance server and download latest almanac and ephemeris data which is then stored within a data store along with a time stamp. In one embodiment, the time stamp is used to determine the age of the ephemeris data, which may be time-sensitive and unusable once its time stamp indicates that it is more than 30 minutes old. At process block 370, the ephemeris and almanac data is loaded within a data store. However, when a connection to the Internet is not available at process block 340, at process block 350, a wait for an Internet connection is initiated and when the connection is available, control flow returns to the start of method 300, as shown in FIG. 4. At process block 380, a GPS receiver is monitored and if it remains inactive for a predetermined wait time of, for example, 15-20 minutes, the process of FIG. 4 is repeated with control flow returning to the start block.

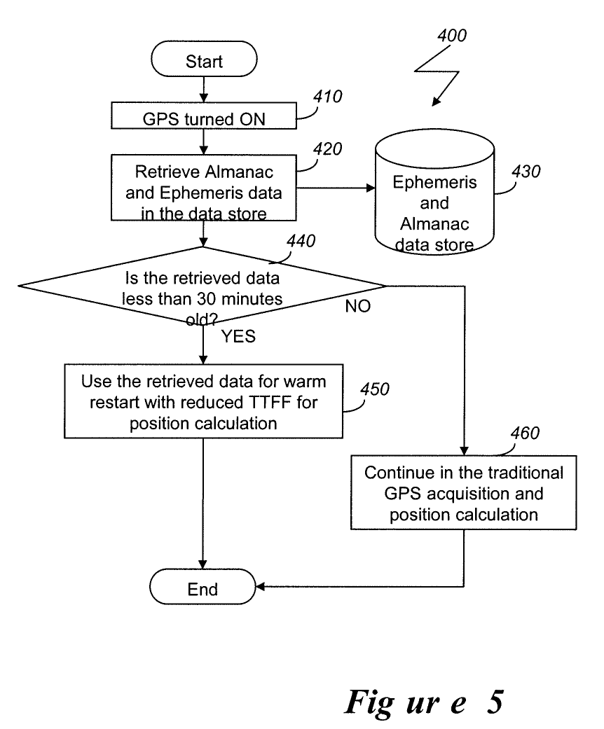

FIG. 5 is a flow chart illustrating a method 400 for performing a warm restart of the GPS receiver. At process block 410, the GPS receiver is turned on. Once turned on at process block 420, almanac and ephemeris data is retrieved from the data storage shown at process block 430. At process block 440, it is determined whether the retrieved data is less than 30 minutes old. Conventionally, when retrieved data is great than 30 minutes old at process block 460, GPS receiver continues the traditional GPS acquisition and position calculation, which requires acquisition of new ephemeris data from each visible satellite required to perform position calculation. Otherwise, at process block 450, the retrieved data is used for efficient searching for satellite and position calculation that can provide an order of magnitude improvement for a time to first fix compared to traditional GPS acquisition and position calculation.

In one embodiment, warm reboot logic 240 performs the method 400, as shown in FIG. 5. In one embodiment, the warm reboot logic 240 using, for example, assistance data capturing logic 270, may establish an active connection to a network server, such as an assistance server to quickly download or acquire assistance data. In one embodiment, downloading assistance data whenever the mobile platform device or MPC system is connected to the network, fresh (not older than 15-20 minutes) assistance data is available to the GPS when turned on. Such available assistance data enables a warm reboot of the GPS receiver to reduce a time to first fix (TTFF) by avoiding the additional time required to download ephemeris data from visible satellites.

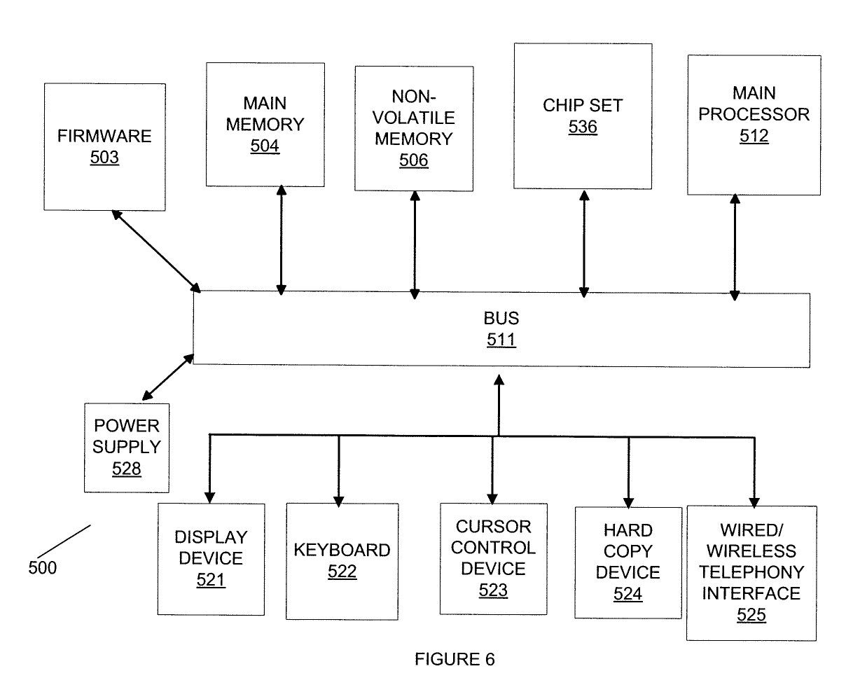

FIG. 6 illustrates a block diagram of an example computer system that may use an embodiment of faster GPS location using pre-downloaded assistance data for mobile platforms computer, according to one embodiment. In one embodiment, computer system 500 comprises a communication mechanism or bus 508 for communicating information, and an integrated circuit component such as a main processing unit 502 coupled with bus 508 for processing information. One or more of the components or devices in the computer system 500 such as the main processing unit 602 or a chipset 610 may use an embodiment of the GPS management logic (GML) 200, as shown in FIG. 2. The main processing unit 502 may consist of one or more processor cores working together as a unit.

Computer system 500 further comprises a random access memory (RAM) or other dynamic storage device 515 (referred to as main memory) coupled to bus 508 for storing information and instructions to be executed by main processing unit 502. Main memory 615 also may be used for storing temporary variables or other intermediate information during execution of instructions by main processing unit 502.

Firmware 519 may be a combination of software and hardware, such as Electronically Programmable Read-Only Memory (EPROM) that has the operations for the routine recorded on the EPROM. The firmware 519 may embed foundation code, basic input/output system code (BIOS), or other similar code. The firmware 519 may make it possible for the computer system 500 to boot itself.

Computer system 500 also comprises a read-only memory (ROM) and/or other static storage device 518 coupled to bus 508 for storing static information and instructions for main processing unit 502. The static storage device 518 may store OS level and application level software.

Computer system 500 may further be coupled to or have an integral display device 530, such as a cathode ray tube (CRT) or liquid crystal display (LCD), coupled to bus 508 for displaying information to a computer user. A chipset may interface with the display device 530.

An alphanumeric input device (keyboard) 532, including alphanumeric and other keys, may also be coupled to bus 508 for communicating information and command selections to main processing unit 502. An additional user input device is cursor control device 533, such as a mouse, trackball, trackpad, stylus, or cursor direction keys, coupled to bus 508 for communicating direction information and command selections to main processing unit 502, and for controlling cursor movement on a display device 530. A Chipset may interface with the input/output devices.

Another device that may be coupled to bus 508 is a power supply such as a battery and Alternating Current adapter circuit. Furthermore, a sound recording and playback device, such as a speaker and/or microphone (not shown) may optionally be coupled to bus 508 for audio interfacing with computer system 500. Another device that may be coupled to bus 508 is a wireless communication module 520. The wireless communication module 520 may employ a Wireless Application Protocol to establish a wireless communication channel. The wireless communication module 520 may implement a wireless networking standard, such as the 802.11 Standard.

As shown in FIG. 6, wireless communication device 520 may operate according to a wireless network protocol, such as, for example, the Institute of Electronic Engineers (IEEE) 802.11 Standard (e.g., IEEE Std. 802.11-1997, 802.11a, 802.11e, 802.11n, etc.). In one embodiment, wireless communications device may operate according to an 802.11 Standard for providing a mobile user with a connection to a local area network (LAN) through an radio frequency (RF) connection. However, it should be recognized that access to a wireless local area network (WLAN) is not limited to the 802.11 Standard, but may include Hyper-Lan2, as well as future potential standards for any point-to-point wireless link or network.

In one embodiment, wireless communication device 520 may provide support for a wireless network protocol for connection to a wireless wide area network (WWAN). In one embodiment, wireless communications device 520 may include virtual private network (VPN) logic 544 for automating access to a wireless network without user intervention.

In one embodiment, the software used to facilitate the routine can be embedded onto a machine-readable medium. A machine-readable medium includes any mechanism that provides (i.e., stores and/or transmits information in a form accessible by a machine (e.g., a computer, network device, personal digital assistant, manufacturing tool, any device with a set of one or more processors, etc.). For example, a machine-readable medium includes recordable/non-recordable media (e.g., read only memory (ROM) including firmware; random access memory (RAM); magnetic disk storage media; optical storage media; flash memory devices; etc.), as well as electrical, optical, acoustical or other form of propagated signals (e.g., carrier waves, infrared signals, digital signals, etc.); etc.

### ALTERNATE EMBODIMENTS

It will be appreciated that, for other embodiments, a different system configuration may be used. For example, while the system 100 includes a single CPU 102, for other embodiments, a chip multiprocessor (CMP) system (where one or more processors cores may be similar in configuration and operation to the CPU 110 described above) may benefit from the faster GPS location using pre-downloaded assistance data of various embodiments. Further different type of system or different type of computer system such as, for example, a server, a workstation, a desktop computer system, a gaming system, an embedded computer system, a blade server, etc., may be used for other embodiments.

Elements of embodiments of the present invention may also be provided as a machine-readable medium for storing the machine-executable instructions. The machine-readable medium may include, but is not limited to, flash memory, optical disks, compact disks-read only memory (CD-ROM), digital versatile/video disks (DVD) ROM, random access memory (RAM), erasable programmable read-only memory (EPROM), electrically erasable programmable read-only memory (EEPROM), magnetic or optical cards, propagation media or other type of machine-readable media suitable for storing electronic instructions. For example, embodiments described may be downloaded as a computer program which may be transferred from a remote computer (e.g., a server) to a requesting computer (e.g., a client) by way of data signals embodied in a carrier wave or other propagation medium via a communication link (e.g., a modem or network connection).

It should be appreciated that reference throughout this specification to “one embodiment” or “an embodiment” means that a particular feature, structure or characteristic described in connection with the embodiment is included in at least one embodiment. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments.

In the above detailed description of various embodiments, reference is made to the accompanying drawings, which form a part hereof, and in which are shown by way of illustration, and not of limitation, specific embodiments in which the invention may be practiced. In the drawings, like numerals describe substantially similar components throughout the several views. The embodiments illustrated are described in sufficient detail to enable those skilled in to the art to practice the teachings disclosed herein. Other embodiments may be utilized and derived therefrom, such that structural and logical substitutions and changes may be made without departing from the scope of this disclosure. The following detailed description, therefore, is not to be taken in a limiting sense, and the scope of various embodiments is defined only by the appended claims, along with the full range of equivalents to which such claims are entitled.

Having disclosed embodiments and the best mode, modifications and variations may be made to the disclosed embodiments while remaining within the scope of the embodiments as defined by the following claims.

What is claimed is:

1. A method comprising:
periodically acquiring assistance data when a global positioning system (GPS) receiver is disabled due to a spatial location of a mobile platform device (MPD); and
in response to activation of the GPS receiver, providing the assistance data to the GPS receiver to reduce a time to first fix (TTFF) following lock onto a predetermined number of visible satellites to establish a current spatial location of the MPD.

2. The method of claim 1, wherein periodically acquiring further comprises:
(a) determining whether a network connection is available if a GPS receiver is disabled due to the spatial location of the MPD;
(b) connecting to an assistance server;
(c) downloading current almanac and ephemeris data; and
(d) storing the downloaded data with a time stamp; and
(e) repeating (a)-(d) following expiration of the predetermined wait time until the activation of the GPS receiver.

3. The method of claim 1, wherein the GPS receiver is disabled due to movement of the MPD by a user to a spatial location where a GPS signal strength is weak.

4. The method of claim 1, wherein providing the boot strap data further comprises:
retrieving almanac and ephemeris data in a data store if activation of the GPS is detected;
verifying that the retrieved ephemeris data is less than 30 minutes old; and
using the retrieved data for satellite search and position calculation.

5. The method of claim 1, wherein the GPS receiver is activated due to one of user movement of the MPD to spatial location where GPS signal strength is strong or if the user activates the GPS receiver.

6. A method comprising:
detecting, during a disabled state of a global positioning system (GPS) receiver, a wake up event;
retrieving assistance data acquired when a global positioning system (GPS) receiver is disabled due to a spatial location of a mobile platform device (MPD); and
initiating a warm reboot of the GPS receiver according to the assistance data to establish a current spatial location of the MPD if the GPS receiver is in the disabled state for more than a predetermined period of time.

7. The method of claim 1, wherein the predetermined period of time is about 30 minutes.

8. The method of claim 6, wherein the GPS receiver is issued a wake up event if a navigation message is received from a GPS signal.

9. The method of claim 6, where initiating the warm reboot of the GPS receiver, further comprises:
locking onto a predetermined number of visible satellites according to almanac data from the assistance data;
determining an exact location of each of the predetermined number of visible satellites according to ephemeris data from the assistance data; and
establishing a current spatial location of the MPD according to a distance between the GPS receiver and each of the predetermined number of visible satellites.

10. The method of claim 9, further comprising:
retrieving ephemeris data for each of the predetermined visible satellites if the ephemeris data from the assistance data is greater than 30 minutes old.

11. An article of manufacture having a machine-readable storage medium encoded with data, wherein the data, when accessed by a machine, results in machine performing operations comprising:
detecting deactivation of a global positioning system (GPS) receiver due to user movement of a mobile platform device (MPD);
if the GPS receiver is in the disabled state for more than a predetermined period of time, acquiring assistance data from a wireless network connection; and
in response to activation of the GPS receiver, providing assistance data to the GPS receiver to enable a warm restart of the GPS receiver if the GPS receiver is in the disabled state for more than the predetermined period.

12. The article of manufacture of claim 11, wherein the first predetermined period of time is less than a second predetermined period of time.

13. The article of manufacture of claim 11, further comprising:
providing the assistance data to the GPS receiver to reduce a time to first fix (TTFF) following lock onto a predetermined number of visible satellites to establish a current spatial location of the MPD.

14. The article of manufacture of claim 11, wherein the GPS receiver is activated in response to detection of a navigation message from a GPS satellite.

15. A system comprising:
a station including:
a global positioning system (GPS) receiver to establish a current spatial location according to a plurality of visible satellites;
a communications interface to communicate with an access point of a network;
a GPS management logic including warm reboot logic to periodically acquire assistance data via the network connection when the GPS receiver is deactivated, the warm reboot logic to initiate a warm reboot of the GPS receiver if the GPS receiver is in the disabled state for more than a predetermined period of time; and
a direct current (DC) power source, wherein the DC power source couples to the station.

16. The system of claim 15, wherein the GPS management logic further comprises:
assistance data verification logic to verify ephemeris data from the assistance data, acquired when the GPS receiver is disabled, is less than 30 minutes old, the assistance data verification logic to retrieve the ephemeris data for each of a predetermined number of visible satellites if the ephemeris data from the assistance data is greater than 30 minutes old.

17. The system of claim 15, wherein the GPS receiver is activated in response to detection of a navigation message from a GPS signal.

18. The system of claim 17, wherein the warm reboot logic is further to provide the assistance data to the GPS receiver to reduce the time to first fix (TTFF) following lock onto a predetermined number of visible satellites to establish a current spatial location.

19. The system of claim 18, wherein the TTFF is comparable to a warm start of the GPS receiver.

20. The system of claim 15, wherein the GPS management logic acquires ephemeris data and almanac data as the assistance data from an assistance server via a wireless network connection.
